(19) United States
(12) Patent Application Publication
(10) Pub. No.: US 2007/0190342 A1
(43) Pub. Date: Aug. 16, 2007

(54) Protective film

(76) Inventor: Yu-Sheng Teng, Lujhou City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/353,116

(22) Filed: Feb. 14, 2006

(51) Int. Cl. B32B 9/04; B32B 27/32

(52) U.S. Cl. 428/447; 428/523

(57) ABSTRACT

A protective film includes a basic material, an anti-scratch or anti-glare layer on an upper side of the basic material, an anti-smudge layer on an upper side of the anti-scratch or anti-glare layer, and an adhesive layer on a lower side of the basic material for sticking to an object; the anti-scratch or anti-glare layer has a certain hardness and can reduce reflection of light; the anti-smudge layer has a large water contact angle; further, a detaching layer is positioned on a lower side of the adhesive layer therefore the adhesive layer is allowed to stick to an object after the detaching layer is removed.

### BACKGROUND OF THE INVENTION

1. Field of the Invention

The present invention relates to a protective film, more particularly one, which is resistant to greasy-dirt and scratching, and glare light, and which includes a basic material, an anti-scratch or anti-glare layer on an upper side of the basic material, an anti-smudge layer on an upper side of the anti-scratch or anti-glare layer, and an adhesive layer on a lower side of the basic material.

2. Brief Description of the Prior Art

Many electronic appliances are getting smaller in size and lighter in weight with progress of technology. LCD, PDP monitors are relatively small-sized and light-weighted as compared with early CRT monitors, and they are radiation-free, power-saving, and have high brightness.

Protective films are stuck on display screens before monitors are shipped out of the factories where they are manufactured. And, when monitors are used, protective films can be stuck on the display screens to protect the display screens from water and scratch as well as making the display screens anti-glare. Referring to FIG. 3, a currently existing protective film 9 includes a basic material 91, an anti-scratch layer 92 on one side of the basic material 91, and an adhesive layer 93. The anti-scratch layer 92 has a certain thickness and hardness, and it has hit and scratch resistant capability. The adhesive layer 93 is formed on the other side of the basic material 91 for sticking the protective film 9 to the surface of an object, e.g. an LCD display screen, and a piece of glass.

However, the basic material 91 with the anti-scratch layer 92 don't have other functions except protecting the display screen from hit, scratch, and sand blown by the wind. Furthermore, the materials of the protective film have water affinity; when water or greasy dirt 94 is splashed on the protective film 9, there will be relatively small water contact angle (θ1), and the surface of the protective film 9 will be stained with water (or greasy dirt) 94, which is difficult to get rid of even if the protective film 9 is flung or wiped. Consequently, the electronic appliance with the protective film 9 will be humidified and damaged over time. And, the images on the display screen can't be clearly seen because of the existence of perspiration or greasy dirt difficult to remove from the protective film 9.

### SUMMARY OF THE INVENTION

It is a main object of the invention to provide a protective film, which performs relatively well in preventing greasy dirt from attaching, and which is easier to clean.

It is another object of the invention to provide a protective film, which will reduce reflection of light from it, and allow more light to pass through.

The protective film of the present invention includes a basic material, an anti-scratch or anti-glare layer on an upper side of the basic material, an anti-smudge layer on an upper side of the anti-scratch or anti-glare layer, and an adhesive layer on a lower side of the basic material to stick to an object. The anti-scratch or anti-glare layer has a certain hardness and can reduce reflection of light to a certain extent while the anti-smudge layer has a large water contact angle.

### BRIEF DESCRIPTION OF THE DRAWINGS

The present invention will be better understood by referring to the accompanying drawings, wherein:

FIG. 1 is a sectional view of the protective film of the invention,

FIG. 2 is a view showing the use of the protective film of the present invention, and

FIG. 3 is a sectional view of the currently existing protective film.

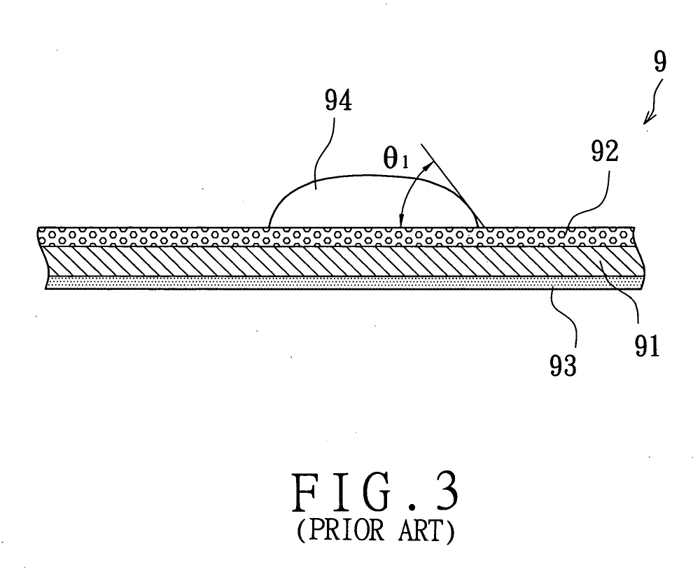

### DETAILED DESCRIPTION OF THE PREFERRED EMBODIMENTS

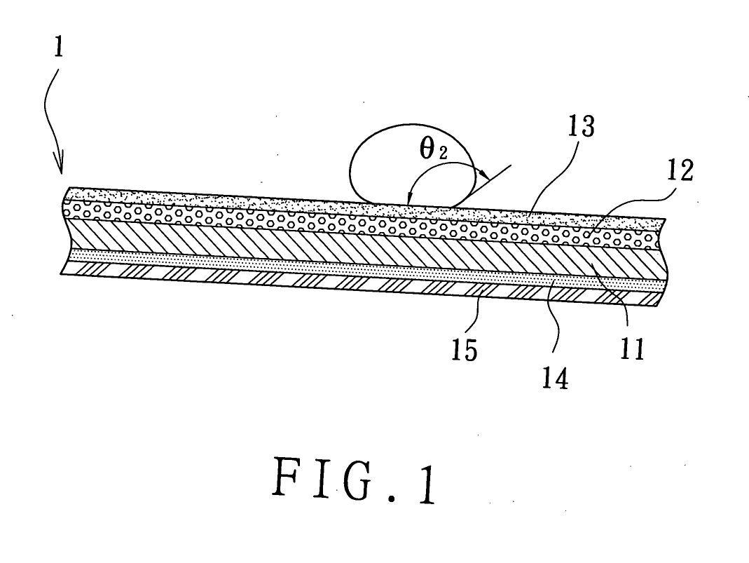

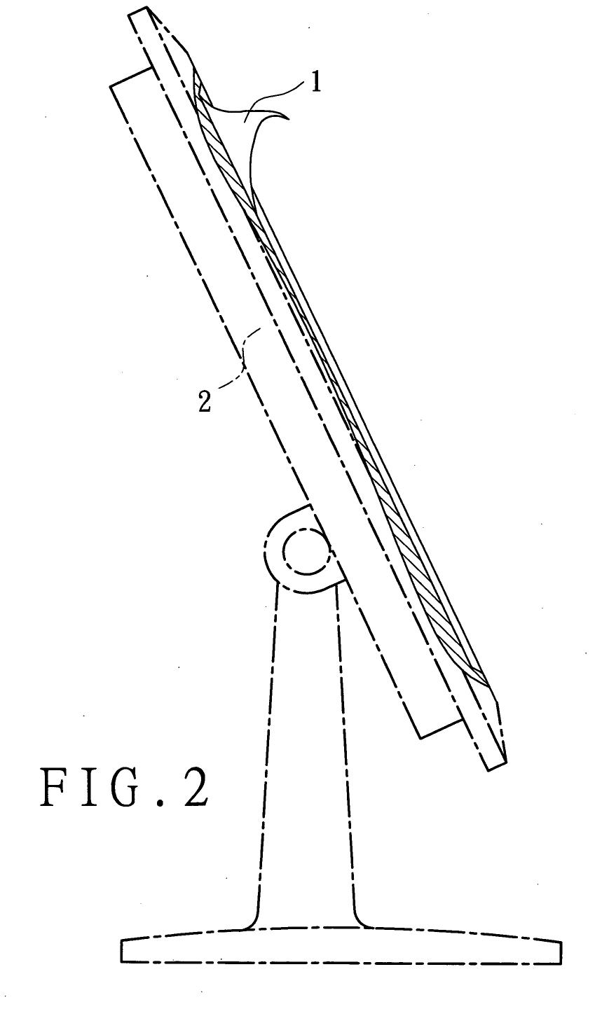

Referring to FIGS. 1 and 2, a preferred embodiment of a protective film 1 in the present invention includes a basic material 11, an anti-scratch or anti-glare layer 12, an anti-smudge layer 13, and an adhesive layer 14.

The basic material 11 is made of appropriate materials, and has a certain thickness. The anti-scratch or anti-glare layer 12 is on an upper side of the basic material 11, and it has a certain hardness and can reduce reflection of light, thus being capable of preventing dazzle and relatively scratch-resistant for protecting the surface of an object, on which the protective film 1 is stuck; the anti-scratch or anti-glare layer 12 can prevent scratches from being formed by objects whose hardness measured by a pencil hardness tester is above 1H.

The anti-smudge layer 13 is positioned on an upper side of the anti-scratch or anti-glare layer 12, and it has a relatively large water contact angle θ2, which will fall between 90 degrees and 120 degrees. The adhesive layer 14 is positioned on a lower side of the basic material 11, and it is preferably made of at least one material chosen from a group including acryl, silicon, and rubber. Further, a detaching layer 15 is on a lower side of the adhesive layer 14. Therefore, the protective film 1 can stick to an object, e.g. a LCD display screen 2, with the help of the adhesive layer 14 after the detaching layer 15 is detached from the adhesive layer 14.

From the above description, it can be easily seen that the protective film of the present invention can prevent formation of scratches, dazzle, and has relatively low reflection rate and allows more light to pass through; when compared with the currently existing protective film, the present invention performs better in preventing greasy dirt and dust from attaching, and is easier to clean; not only can the anti-scratch or anti-glare layer 12 resist scratching, it can reduce reflection and will allow more light to pass through the protective film 1 as well.

What is claimed is:

1. A protective film, comprising
a basic material;
an anti-scratch or anti-glare layer on an upper side of the basic material; the anti-scratch or anti-glare layer having a certain hardness and being capable of reducing reflection of light;
an anti-smudge layer on an upper side of the anti-scratch or anti-glare layer; the anti-smudge layer having a large water contact angle; and
an adhesive layer on a lower side of the basic material to stick to an object.

2. The protective film as claimed in claim 1, wherein a detaching layer is positioned on a lower side of the adhesive layer, and the adhesive layer is allowed to stick to an object after the detaching layer is removed.

3. The protective film as claimed in claim 1, wherein the adhesive layer is made of at least one material chosen from a group including acryl, silicon, and rubber.

4. The protective film as claimed in claim 1, wherein the water contact angle of the anti-smudge falls between 90 degrees and 120 degrees.
